(19) United States
(12) Patent Application Publication
(10) Pub. No.: US 2022/0067649 A1
(43) Pub. Date: Mar. 3, 2022

(54) GOODS DISTRIBUTION TRACKING APPARATUS / METHOD USING DECENTRALIZED NETWORK AND SELF-SOVEREIGN ID

(71) Applicants: Hwoa In CHOI, Seoul (KR); Yoon Il CHOI, Gyeonggi-do (KR)

(72) Inventors: Hwoa In CHOI, Seoul (KR); Yoon Il CHOI, Gyeonggi-do (KR)

(21) Appl. No.: 17/406,901

(22) Filed: Sep. 8, 2021

(30) Foreign Application Priority Data
Aug. 27, 2020 (KR) 10-2020-0108263

(51) Int. Cl. G06Q 10/08; G06Q 20/40; G06K 7/14

(52) U.S. Cl. CPC G06Q 10/0833; G06K 7/143; G06Q 20/401; G06Q 10/087

(57) ABSTRACT

A goods distribution tracking apparatus and method may request an issue of a verifiable credential including the DID of a user and distribution-related information on goods distributed by the user, receive the verifiable credential issued in response to the issue request, output the received verifiable credential in the form of encoded identification information, accurately and objectively track a goods distribution process without exposing the personal information of the user and the like, and enable a user, involved in each distribution process, to pay only the cost required for using the corresponding distribution process.

### CROSS-REFERENCE TO RELATED APPLICATION

The present application claims priority to Korean Patent Application No. 10-2020-0108263 filed on Aug. 27, 2020, the entire contents of which are incorporated herein by reference.

### BACKGROUND

### 1. Technical Field

The present disclosure relates to goods distribution, and more particularly, to an apparatus and method for tracking goods distribution.

### 2. Related Art

A person who wants to discard waste needs to declare the waste to a local self-governing body in advance, and purchase a disposal sticker by paying the disposal cost of the waste. When the payment has been settled, the person attaches the disposal sticker to the waste and then discharges the waste, the disposal sticker containing the personal information of the discharger and information indicating that the payment has been settled. This is a general waste discharge process at the moment.

During this process, however, various problems may occur. For example, the personal information such as the name, telephone number and address of the waste discharger may be exposed through the disposal sticker, somebody may take off the disposal sticker and fraudulently use the disposal sticker, or the waste discharger may not have a refund even though the waste discharger does not discharge the waste after purchasing the disposal sticker.

### RELATED ART DOCUMENT

### Patent Document

(Patent Document 1) None

### Non-Patent Document

(Non-Patent Document 1) None

### SUMMARY

Various embodiments are directed to a goods distribution tracking apparatus and method which can accurately and objectively track a goods distribution process without exposing the personal information of a user or the like, and enable a user, involved in each distribution process, to pay only the cost required for using the corresponding distribution process.

Also, various embodiments are directed to a goods distribution tracking apparatus and method which can continuously track a goods distribution process, accurately calculate or estimate the cost required for each distribution operation, based on the tracking result, and establish a policy for efficiently constructing all distribution steps. For example, when the goods distribution tracking apparatus and method are applied to each of the distribution steps such as waste discharge, waste collection and transportation, waste disposal and waste recycling, a local self-governing body in charge of overall waste disposal processes can accurately find out ‘whether each waste was buried in the ground or sold second-hand’ and accurately find out ‘what price the waste was sold at, when the waste was recycled’. Thus, the related budget may be efficiently planned, and the corresponding policy may be effectively established.

In an embodiment, a goods distribution tracking apparatus may include: a verifiable credential control unit configured to request an issue of a verifiable credential containing a user's DID (Decentralized Identifier) and distribution-related information on goods distributed by the user, and receive the verifiable credential issued in response to the issue request; and a verifiable credential output unit configured to output the received verifiable credential in the form of encoded identification information. The verifiable credential control unit may register the issued verifiable credential in a decentralized network.

The goods distribution tracking apparatus may be provided for each user involved in the distribution, and the verifiable credential control unit may request an issue of the verifiable credential into which the distribution-related information of the user corresponding to the verifiable credential control unit is reflected. The verifiable credential control unit may request an issue of the verifiable credential into which at least some pieces of the distribution-related information of all users are reflected, wherein all the users are involved in previous distribution steps and include the user to which the verifiable credential control unit belongs. Alternatively, the verifiable credential control unit may request an issue of the verifiable credential including the unique distribution-related information of the user having the goods distribution tracking apparatus to which the verifiable credential control unit belongs. In the latter case, the DID of the user may include the DIDs of one or more users involved in the distribution.

The goods distribution tracking apparatus may communicate with a verifiable credential issue unit located outside the goods distribution tracking apparatus, and the verifiable credential issue unit may determine whether the issue request of the verifiable credential control unit contains false information, and then issue and transmit the verifiable credential corresponding to the issue request to the verifiable credential control unit, when determining that the issue request of the verifiable credential control unit contains no false information.

The verifiable credential output unit may output the received verifiable credential in the form of a QR code or barcode onto a screen or paper.

The distribution-related information may include at least some of the types and quantities of the goods, the cost required for distributing the goods, and information on whether the cost has been paid.

In an embodiment, a goods distribution tracking method may include: requesting an issue of a verifiable credential containing a user's DID and distribution-related information on goods distributed by the user; receiving the verifiable credential issued in response to the issue request; and outputting the received verifiable credential in the form of encoded identification information. The receiving of the verifiable credential may include registering the issued verifiable credential in a decentralized network.

The goods distribution tracking method may be performed by each user involved in the distribution, and the requesting of the issue of the verifiable credential, which is performed by each user, may include requesting an issue of the verifiable credential into which the unique distribution-related information of the user is reflected.

The goods distribution tracking method may be performed by each user involved in the distribution, and the requesting of the issue of the verifiable credential, which is performed by credential into which at least some pieces of the distribution-related information of all users are reflected, wherein all the users are involved in previous distribution steps and include the user. In this case, the DID of the user may include the DIDs of one or more users involved in the distribution.

The outputting of the verifiable credential may include outputting the received verifiable credential in the form of a QR code or barcode onto a screen or paper.

The distribution-related information may include at least some of the types and quantities of the goods, the cost required for distributing the goods, and information on whether the cost has been paid.

In order to achieve the above-described purpose, a computer readable recording medium may store a computer program for executing, through a computer, a goods distribution tracking method including: requesting an issue of a verifiable credential containing a user's DID and distribution-related information on goods distributed by the user; receiving the verifiable credential issued in response to the issue request; and outputting the received verifiable credential in the form of encoded identification information.

In accordance with the embodiments of the present disclosure, the goods distribution tracking apparatus and method can accurately and objectively track a goods distribution process without exposing the personal information of a user or the like, and enable a user, involved in each distribution process, to pay only the cost required for using the corresponding distribution process.

Also, the goods distribution tracking apparatus and method can continuously track a goods distribution process, accurately calculate or estimate the cost required for each distribution operation, based on the tracking result, and establish a policy for efficiently constructing all distribution steps. For example, when the goods distribution tracking apparatus and method are applied to each of the distribution steps such as waste discharge, waste collection and transportation, waste disposal and waste recycling, a local self-governing body in charge of overall waste disposal processes can accurately find out ‘whether each waste was buried in the ground or sold second-hand’ and accurately find out ‘what price the waste was sold at, when the waste was recycled’. Thus, the related budget may be efficiently planned, and the corresponding policy may be effectively established.

### BRIEF DESCRIPTION OF THE DRAWINGS

FIGS. 1 and 2 are block diagrams for describing a goods distribution tracking apparatus in accordance with at least an embodiment of the present disclosure.

FIG. 3 is a flowchart illustrating a goods distribution tracking method in accordance with at least an embodiment of the present disclosure.

### DETAILED DESCRIPTION

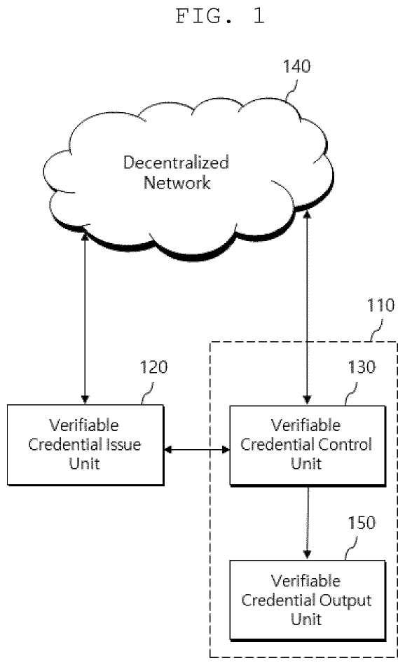

Referring to FIG. 1, a goods distribution tracking apparatus in accordance with at least an embodiment of the present disclosure will be described as follows.

First, the goods distribution tracking apparatus in accordance with at least the embodiment of the present disclosure has been devised to attempt to solve the problems of the above-described waste disposal system. However, the goods distribution tracking apparatus may be applied to not only the waste disposal industry, but also the distribution industry of all distributable goods such as wastes or delivery goods.

The goods distribution tracking apparatus 110 may include a verifiable credential control unit 130 and a verifiable credential output unit 150, and communicate with a verifiable credential issue unit 120.

The verifiable credential control unit 130 of the goods distribution tracking apparatus 110 may request the verifiable credential issue unit 120 to issue a user's DID (Decentralized Identifier) and a verifiable credential containing distribution-related information on goods distributed by the user.

In this specification, ‘DID’ refers to a decentralized identity authentication means that is self-owned and managed, not an authentication means such as an authentication certificate or residence registration card, which is managed by a central organization, and is also referred to as ‘mobile ID’ or ‘self-sovereign ID’.

Furthermore, in this specification, ‘goods’ collectively indicate all kinds of distributable material things, and wastes and delivery products are only example of such goods. Furthermore, the distribution-related information indicates information on at least some of the types and quantities of goods, the cost required for distributing the goods, and information on whether the cost has been paid.

In this specification, ‘verifiable credential’ indicates ‘credential data’ such as ‘ID’, which can be used in a decentralized network such as a blockchain. At this time, the credential data indicates data to verify that a user who desires to distribute goods has a qualification for legal goods distribution. The user indicates a person who uses the goods distribution tracking apparatus in accordance with at least the embodiment of the present disclosure.

When the verifiable credential control unit 130 requests the verifiable credential issue unit 120 to issue verifiable credential information as described above, the verifiable credential issue unit 120 determines whether the issue request contains false information. Then, when it is determined that the issue request contains no false information, the verifiable credential issue unit 120 issues and transmits a verifiable credential corresponding to the issue request to the verifiable credential control unit 130. The verifiable credential issue unit 120 may register the verifiable credential, issued by itself, in a decentralized network 140 such as a blockchain.

The verifiable credential control unit 130 receives ‘the verifiable credential’ issued by the verifiable credential issue unit 120, and then transmits the received verifiable credential to the verifiable credential output unit 150. Like the verifiable credential issue unit 120 that can register the verifiable credential in the decentralized network 140, the verifiable credential control unit 130 may also register the verifiable credential in the decentralized network 140.

The verifiable credential output unit 150 may output the verifiable credential, received from the verifiable credential issue unit 120 by the verifiable credential control unit 130, in the form of identification information obtained by encoding the verifiable credential. In this specification, ‘encoding’ may indicate processing information such that a person cannot recognize the meaning of the information with the naked eye, and the identification information outputted by the verifiable credential output unit 150 may be recognized only through a dedicated terminal or the like. For example, the verifiable credential output unit 150 may output the verifiable credential, received from the verifiable credential issue unit 120 by the verifiable credential control unit 130, in the form of a QR code or bar code onto a screen or paper. The QR code or barcode is only an example of ‘encoded verifiable credential’, and the form of the encoded verifiable credential is not limited to the QR code and the barcode.

In accordance with at least an embodiment of the present disclosure, there may be one or more goods distribution tracking apparatuses 110 which can communicate with the verifiable credential issue unit 120, while there is only one verifiable credential issue unit 120. In this case, each user who is involved in goods distribution may have the goods distribution tracking apparatus in accordance with the embodiment of the present disclosure. At this time, the verifiable credential control unit 130 included in each of the goods distribution tracking apparatuses may request the verifiable credential issue unit 120 to issue a verifiable credential into which the ‘unique’ distribution-related information of ‘the goods distribution tracking apparatus 110 including the verifiable credential control unit 130’ is reflected, or request the verifiable credential issue unit 120 to issue a verifiable credential into which at least some pieces of distribution-related information of all the goods distribution tracking apparatuses 110 are cumulatively reflected, all the goods distribution tracking apparatuses 110 corresponding to the previous distribution steps and including ‘the goods distribution tracking apparatus 110 including the verifiable credential control unit 130’. In the latter case, ‘the DID of the user’, belonging to the verifiable credential which each verifiable credential control unit 130 has requested the verifiable credential issue unit 120 to issue, may include the DIDs of one or more users involved in the distribution.

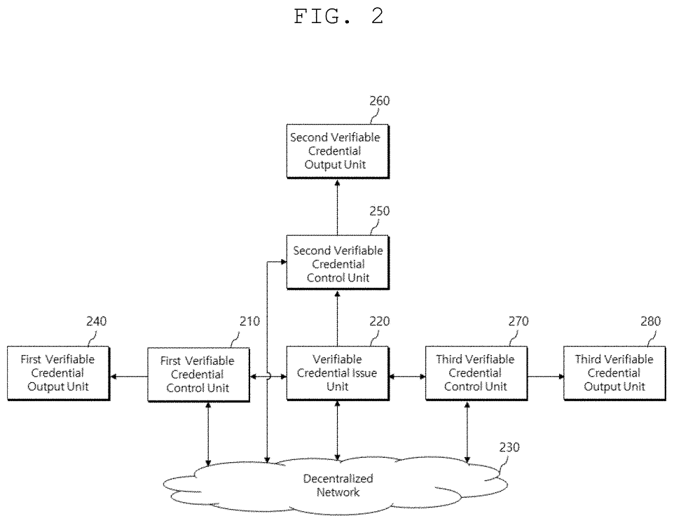

In order to promote the understandings of the above-described contents or specifically the contents of the right above paragraph with reference to a specific example, the case in which the goods distribution tracking apparatus in accordance with at least the embodiment of the present disclosure is applied to the waste disposal industry will be described as follows, with reference to FIG. 2.

In general, users involved in waste distribution are roughly divided into \textcircled{1} a waste discharger, \textcircled{2} a waste managing user such as an environmental office or local self-governing body, \textcircled{3} a waste collecting and transporting company, \textcircled{4} a waste disposal company and \textcircled{5} a waste recycling company. The verifiable credential issue unit 120 illustrated in FIG. 1 is provided for the waste managing user, and the goods distribution tracking apparatus is provided for each of the waste discharger, the waste collecting and transporting company, the waste disposal company and the waste recycling company. For convenience of description, ‘the verifiable credential control unit’ and ‘the verifiable credential output unit’, which constitute the goods distribution tracking apparatus provided for the waste discharger, will be represented by a first verifiable credential control unit 210 and a first verifiable credential output unit 240. Furthermore, ‘the verifiable credential control unit’ and ‘the verifiable credential output unit’, which constitute the goods distribution tracking apparatus provided for the waste collecting and transporting company, will be represented by a second verifiable credential control unit 250 and a second verifiable credential output unit 260. Furthermore, ‘the verifiable credential control unit’ and ‘the verifiable credential output unit’, which constitute the goods distribution tracking apparatus provided for the waste disposal company, will be represented by a third verifiable credential control unit 270 and a third verifiable credential output unit 280. Furthermore, ‘the verifiable credential control unit’ and ‘the verifiable credential output unit’, which constitute the goods distribution tracking apparatus provided for the waste recycling company, will be represented by a fourth verifiable credential control unit (not illustrated) and a fourth verifiable credential output unit (not illustrated).

First, a waste discharging process will be described. The first verifiable credential control unit 210 requests a verifiable credential issue unit 220 of the waste managing user to issue ‘a verifiable credential’ for ‘waste discharge’. The verifiable credential for waste discharge may include \textcircled{1} the DID of the waste discharger and \textcircled{2} information on waste which the waste discharger wants to discard, i.e. information on distribution of the waste. The information may include the type and quantity of the waste, the cost required for disposing of the waste, and information on whether the cost has been paid.

In this case, the verifiable credential issue unit 220 determines whether the verifiable credential requested by the first verifiable credential control unit 210 contains false information (e.g. the type and quantity of the waste declared by the waste discharger or whether the information on the payment for the cost contains false information). When it is determined that the verifiable credential contains no false information, the verifiable credential issue unit 220 issues and transmits ‘a verifiable credential’ for ‘waste discharge’ to the first verifiable credential control unit 210.

The first verifiable credential control unit 210 registers the issued ‘verifiable credential’ for ‘waste discharge’ in a decentralized network 230, and also transmits the verifiable credential to the first verifiable credential output unit 240. The first verifiable credential output unit 240 prints the transmitted ‘verifiable credential’ for ‘waste discharge’ in the form of a QR code, and the waste discharger attaches the QR code printed matter onto the waste, and discharges the waste to a designated place. Since the QR code is encoded, a person cannot understand the QR code with the naked eye. Furthermore, the QR code does not contain personal information such as the resident registration number of the waste discharger, but contains the DID of the waste discharger instead of the resistant registration number. In this case, the QR code does not contain a private key for verifying that the owner of the DID is the waste discharger. Thus, the goods distribution tracking apparatus in accordance with at least the embodiment of the present disclosure can remove a risk of personal information leakage. Furthermore, since the QR code printed matter is only for the DID of the waste discharger, the goods distribution tracking apparatus in accordance with at least the embodiment of the present disclosure can remove a risk of illegal use for a disposal sticker in the current discharge system. As will be described below, the goods distribution tracking apparatus in accordance with at least the embodiment of the present disclosure can track even information on whether the waste corresponding to the QR code printed matter has been actually discharged and disposed of. Thus, when the QR code printed matter is not actually used, the corresponding cost may be refunded.

Next, ‘a waste collecting and transporting procedure’ which may be a subsequent procedure of ‘the waste discharge procedure’ will be described.

The second verifiable credential control unit 250 requests the verifiable credential issue unit 220 of the waste managing user to issue ‘a verifiable credential’ for ‘waste collection and transportation’. The verifiable credential for waste collection and transportation may include \textcircled{1} the DID of the waste collecting and transporting company and \textcircled{2} information on the waste which the waste collecting and transporting company wants to collect and transport, i.e. information on the distribution of the waste. The information may include the specification of the waste, the collection day and place of the waste, the transportation day, and the disposal company and place. Such a verifiable credential for waste collection and transportation may include the above-described ‘verifiable credential’ for ‘waste discharge’ or be a verifiable credential containing only information on waste collection and transportation. In the present embodiment, however, the former case will be taken as an example, for convenience of description.

In this case, the verifiable credential issue unit 220 determines whether the verifiable credential requested by the second verifiable credential control unit 250 contains false information (e.g. whether the information on the collection day and place declared by the waste collecting and transporting company contain false information). When it is determined that the verifiable credential contains no false information, the verifiable credential issue unit 220 issues and transmits ‘the verifiable credential’ for ‘waste collection and transportation’ to the second verifiable credential control unit 250.

The second verifiable credential control unit 250 registers the issued verifiable credential for waste collection and transportation in the decentralized network 230, and also transmits the verifiable credential to the second verifiable credential output unit 260. The second verifiable credential output unit 260 may output the transmitted verifiable credential for waste collection and transportation in the form of encoded identification information onto the screen. The verifiable credential may not be identified with the naked eye on the screen, but a computer such as a dedicated terminal of the waste collecting and transporting company may recognize the verifiable credential. Next, ‘a waste disposal procedure’ which may be a subsequent process of ‘the waste collection and transportation procedure’ will be described.

First, the third verifiable credential control unit 270 requests the verifiable credential issue unit 220 of the waste managing user to issue ‘a verifiable credential’ for ‘waste disposal’. The verifiable credential for ‘waste disposal’ may include \textcircled{1} the DID of the waste disposal company and \textcircled{2} information on the waste to be disposed of, i.e. information on the distribution of the waste. The information may include a waste disposal method of the waste disposal company and the like. Such a verifiable credential for ‘waste disposal’ may include the above-described ‘verifiable credentials’ for ‘waste discharge’ and ‘waste collection and transportation’, or be a verifiable credential containing only information on waste disposal. In the present embodiment, however, only the former case will be taken as an example, for convenience of description.

The verifiable credential issue unit 220 determines whether the verifiable credential requested by the third verifiable credential control unit 270 contains false information (e.g. whether the information on the waste disposal method declared by the waste disposal company contains false information). When it is determined that the verifiable credential contains no false information, the verifiable credential issue unit 220 issues and transmits the verifiable credential for waste disposal to the third verifiable credential control unit 270.

The third verifiable credential control unit 270 registers the issued verifiable credential for waste disposal in the decentralized network 230, and also transmits the verifiable credential to the third verifiable credential output unit 280. The third verifiable credential output unit 290 may output the transmitted verifiable credential for waste disposal in the form of encoded identification information onto the screen. The verifiable credential may not be identified with the naked eye on the screen, but be recognized by a computer such as a dedicated terminal of the waste disposal company.

Finally, ‘a waste recycling procedure’ which may be a subsequent procedure of ‘the waste disposal procedure’ will be described.

The fourth verifiable credential control unit (not illustrated) requests the verifiable credential issue unit 220 of the waste managing user to issue ‘a verifiable credential’ for ‘waste recycling’. The verifiable credential for ‘waste recycling’ may include \textcircled{1} the DID of the waste recycling company and \textcircled{2} information on the waste to be recycled, i.e. information on the distribution of the waste. The information may include a waste recycling method of the waste recycling company and the like. Such a verifiable credential for waste recycling may include the above-described ‘verifiable credentials’ for ‘waste discharge’, ‘waste collection and transportation’ and ‘waste disposal’, or be a verifiable credential containing only information on waste recycling. In the present embodiment, however, only the former case will be taken as an example, for convenience of description.

The verifiable credential issue unit 220 determines whether the verifiable credential requested by the fourth verifiable credential control unit (not illustrated) contains false information (e.g. whether the information on the waste recycling method declared by the waste recycling company contains false information). When it is determined that the verifiable credential contains no false information, the verifiable credential issue unit 220 issues and transmits the verifiable credential for waste recycling to the fourth verifiable credential control unit (not illustrated).

The fourth verifiable credential control unit (not illustrated) registers the issued verifiable credential for waste recycling in the decentralized network 230, and also transmits the verifiable credential to the fourth verifiable credential output unit (not illustrated). The fourth verifiable credential output unit (not illustrated) may output the transmitted verifiable credential for waste recycling in the form of encoded identification information onto the screen. The verifiable credential may not be identified with the naked eye on the screen, but be recognized by a computer such as a dedicated terminal of the waste recycling company.

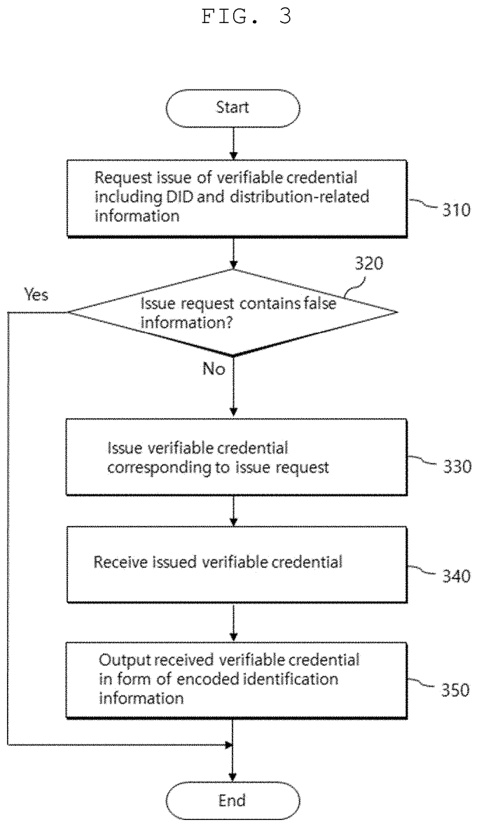

Next, a goods distribution tracking method will be described with reference to FIG. 3. The goods distribution tracking method of FIG. 3 will be described with reference to FIG. 1.

The verifiable credential control unit 130 requests the verifiable credential issue unit 120 to issue a verifiable credential containing \textcircled{1} ‘the DID of a user’ and \textcircled{2} ‘distribution-related information on goods distributed by the user’, in step 310.

After step 310, the verifiable credential issue unit 120 determines whether the verifiable credential requested in step 310 contains false information, in step 320.

When the determination result of step 320 indicates that the verifiable credential contains no false information, the verifiable credential issue unit 120 issues a verifiable credential corresponding to the issue request of step 310 to the verifiable credential control unit 130, in step 330.

After step 330, the verifiable credential control unit 130 receives the verifiable credential issued in step 330 from the verifiable credential issue unit 120, and transmits the received verifiable credential to the verifiable credential output unit 150, in step 340.

After step 340, the verifiable credential output unit 150 outputs the verifiable credential received in step 340 in the form of encoded identification information, in step 350.

A computer readable recording medium in accordance with at least the embodiment of the present disclosure may store a computer program for executing the goods distribution tracking method (see FIG. 3).

The foregoing description of the present disclosure is only for some embodiments, and the person skilled in the art to which the present disclosure pertains can carry out various modifications of the some embodiments without departing from the scope of the claims. Therefore, it should not be interpreted that the claims are limited to the some embodiments.

### INDUSTRIAL APPLICABILITY

The goods distribution tracking apparatus and method in accordance with at least the embodiment of the present disclosure may be used for various businesses related to goods distribution such as delivery distribution or waste disposal.

1. A goods distribution tracking apparatus comprising:
a verifiable credential control unit configured to request an issue of a verifiable credential containing a user's DID (Decentralized Identifier) and distribution-related information on goods distributed by the user, and receive the verifiable credential issued in response to the issue request; and
a verifiable credential output unit configured to output the received verifiable credential in the form of encoded identification information.

2. The goods distribution tracking apparatus of claim 1, wherein the verifiable credential control unit registers the issued verifiable credential in a decentralized network.

3. The goods distribution tracking apparatus of claim 1, wherein the goods distribution tracking apparatus is provided for each user involved in the distribution, and the verifiable credential control unit requests an issue of the verifiable credential into which the distribution-related information of the user corresponding to the verifiable credential control unit is reflected.

4. The goods distribution tracking apparatus of claim 3, wherein the verifiable credential control unit requests an issue of the verifiable credential into which at least some pieces of the distribution-related information of all users are reflected, wherein all the users are involved in previous distribution steps and include the user to which the verifiable credential control unit belongs.

5. The goods distribution tracking apparatus of claim 1, wherein the DID of the user comprises the DIDs of one or more users involved in the distribution.

6. The goods distribution tracking apparatus of claim 1, wherein the goods distribution tracking apparatus is able to communicate with a verifiable credential issue unit located outside the goods distribution tracking apparatus, and the verifiable credential issue unit determines whether the issue request of the verifiable credential control unit contains false information, and then issues and transmits the verifiable credential corresponding to the issue request to the verifiable credential control unit, when determining that the issue request of the verifiable credential control unit contains no false information.

7. The goods distribution tracking apparatus of claim 1, wherein the verifiable credential output unit outputs the received verifiable credential in the form of a QR code or barcode onto a screen or paper.

8. The goods distribution tracking apparatus of claim 1, wherein the distribution-related information comprises at least some of the types and quantities of the goods, the cost required for distributing the goods, and information on whether the cost has been paid.

9. A goods distribution tracking method comprising:
requesting an issue of a verifiable credential containing a user's DID and distribution-related information on goods distributed by the user;
receiving the verifiable credential issued in response to the issue request; and
outputting the received verifiable credential in the form of encoded identification information.

10. The goods distribution tracking method of claim 9, wherein the receiving of the verifiable credential comprises registering the issued verifiable credential in a decentralized network.

11. The goods distribution tracking method of claim 9, wherein the goods distribution tracking method is performed by each user involved in the distribution, and the requesting of the issue of the verifiable credential, which is performed by each user, comprises requesting an issue of the verifiable credential into which the unique distribution-related information of the user is reflected.

12. The goods distribution tracking method of claim 9, wherein the goods distribution tracking method is performed by each user involved in the distribution, and the requesting of the issue of the verifiable credential, which is performed by credential into which at least some pieces of the distribution-related information of all users are reflected, wherein all the users are involved in previous distribution steps and include the user.

13. The goods distribution tracking method of claim 12, wherein the DID of the user comprises the DIDs of one or more users involved in the distribution.

14. The goods distribution tracking method of claim 9, wherein the outputting of the verifiable credential comprises outputting the received verifiable credential in the form of a QR code or barcode onto a screen or paper.

15. The goods distribution tracking method of claim 9, wherein the distribution-related information comprises at least some of the types and quantities of the goods, the cost required for distributing the goods, and information on whether the cost has been paid.

16. A computer readable recording medium configured to store a computer program for executing the method of claim 9 in a computer.
